(19) United States
(12) Patent Application Publication
(10) Pub. No.: US 2017/0027806 A1
(43) Pub. Date: Feb. 2, 2017

(54) MASSAGE STRUCTURE FOR BACKPACK

(71) Applicant: JIEN-WAY LIN, MIAOLI COUNTY (TW)

(72) Inventor: JIEN-WAY LIN, MIAOLI COUNTY (TW)

(21) Appl. No.: 14/809,355

(22) Filed: Jul. 27, 2015

(51) Int. Cl. A61H 7/00; A45F 3/04; A61H 39/04

(52) U.S. Cl. CPC A61H 7/001; A61H 39/04; A45F 3/04; A61H 2205/081; A61H 2201/1652

(57) ABSTRACT

A massage structure to be mounted onto a back portion of a backpack includes a base and a plurality of protrusions. The plurality of protrusions are distributed in a predetermined discrete manner over the base and arranged to align with at least one specific acupoint on a back of a user. Each of the protrusions protrudes outwards away the back portion from the base with a predetermined height for applying massage onto the back of the user carrying the backpack. The massage structure further includes a pair of extended bases upward extended from a top end of each base to the straps of the backpack respectively, and a plurality of extended protrusions formed on the extended bases and arranged to align with at least one specific shoulder acupoint on a shoulder of the user.

### BACKGROUND OF INVENTION

1. Field of the Invention

The invention relates to a massage device, more particularly to a massage structure that can be integrated into a backpack to perform massage in the back of a carrier of the backpack.

2. Description of the Prior Art

It is well known that carrying a heavy backpack can induce fatigue and reduce blood flow to the shoulder and fingers. Empirically, a rough estimate states that blood flow through large and small blood vessels in the upper body will drop nearly 50% in adults carrying backpacks weighing 11.8 kg for ten minutes.

Typically, the backpack always includes straps that rest on an area of the body where they may compress auxiliary veins which cause an abnormal high blood pressure inside the veins and a subsequent decrease of blood flow in the shoulders and arms. Namely, the blood flow of the large and small vessels of the upper extremity area of the body would decrease in an individual while wearing a backpack. That is also to say that the blood flow to the shoulder and arms would be significantly influenced by the straps.

The abnormal blood flow caused by carrying backpacks would often cause the carrier to experience both fatigue and pain in the back. Equally important, a localized temperature rise on the back caused by ill air ventilation between the backpack and the back of the carrier would further make worse the blood circulation of carrier's back that is already compressed to flow abnormally.

Apparently, the major concern herein is the back pain, which is generally among the most common reasons for people to seek medical treatment. Discs, nerves, muscles and arthritis are reasons people could suffer from back pain. While treatments for back pain can vary from stretches to surgery and many things in between, there are massage points (or say acupuncture points or acupoints) that can help to manage back pain, especially the massage points distributed over the erector inaemuscles. Empirically it is well known in the art that for many, massage, known as healing practice that identifies key points on the body and uses pressure to stimulate body's healing capacity, can reduce pain more than physical therapy. Depressing approximately on the massage points may improve local blood circulations around these certain locations, and thus to bring pain relief there around.

### SUMMARY OF THE INVENTION

Accordingly, it is the primary object of the present invention to provide a massage structure for a backpack that is able to perform massage, and thus thereupon substantially improve the local blood circulation at the back of the carrier.

In the present invention, the massage structure is formed as a pad structure to be mounted onto a back portion of a backpack, in which the backpack further has at least one strap connected with the back portion so as to surround user's shoulder. The massage structure comprises a base, a plurality of protrusions and a binding material for fixing the base onto the back portion of the backpack.

The plurality of protrusions are distributed in a predetermined discrete manner over the base and arranged to align with at least one specific acupoint on a back of a user. Each of the protrusions protrudes outwards away from the back portion of the base with a predetermined height and further has a round or small flat tip for applying massage onto a back of a user carrying the backpack.

In a preferable embodiment of the present invention, the massage structure further includes a pair of extended bases upward extended from a top end of each base to the straps of the backpack respectively, and a plurality of extended protrusions formed on the extended bases and arranged to align with at least one specific shoulder acupoint on a shoulder of the user.

All these objects are achieved by the massage structure for a backpack described below.

### BRIEF DESCRIPTION OF THE DRAWINGS

The present invention will be apparent to those skilled in the art by reading the following description of preferred embodiments of the present invention, with reference to the attached drawings, in which:

FIG. 1 is a schematic view of a first embodiment of the massage structure for a backpack in accordance with the present invention;

FIG. 2 is a schematic side view showing the backpack of FIG. 1 is carried by a carrier;

FIG. 3 is a cross-sectional view taken along line 3-3 of FIG. 1, showing the protrusions of the massage unit can be a round tip;

FIG. 4 is a cross-sectional view similar to FIG. 3, showing the protrusions of the massage unit can be a small flat tip;

FIG. 5 is a schematic side view showing the massage units of the present invention are arranged to correspond to erector inaemuscles at both sides of the spinal column of a user;

FIG. 6 is a schematic side view showing the base of the massage unit can be integrated with a back portion of a backpack;

FIG. 7 is a schematic side view showing the base of the massage unit can be attached onto a back portion of a backpack by appropriate binding material;

FIG. 8 is a schematic view of a second embodiment of the massage structure for a backpack in accordance with the present invention; and

FIG. 9 is a schematic side view showing the backpack of FIG. 8 is carried by a carrier.

### DESCRIPTION OF THE PREFERRED EMBODIMENT

The invention disclosed herein is directed to a massage structure for a backpack. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

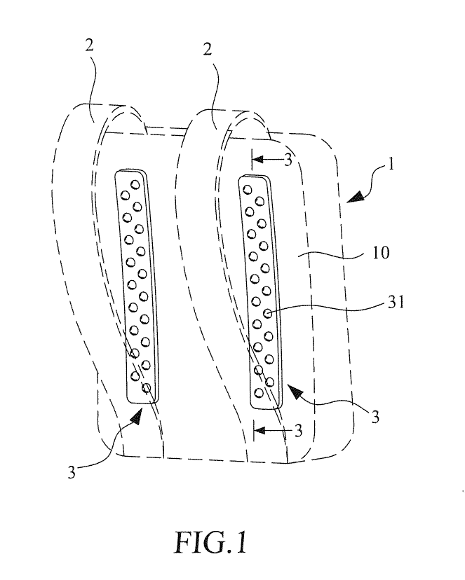

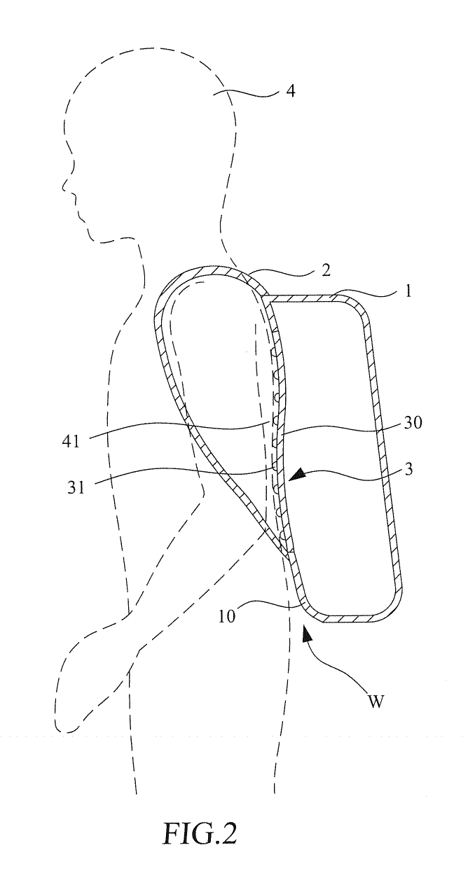

Referring to FIGS. 1-2, a backpack 1 is provided with a pair of spaced straps 2 connected with a back portion 10 of the backpack 1. In the present invention, a pair of spaced massage units 3 is mounted on the back portion 10 of the backpack 1, so as to achieve a massage at the back 41 of the user 4 carrying the backpack 1. Thus, the local blood circulation at the back 41 of the user 4 can be substantially improved. Namely, fatigue at the back 41 of the user 4 induced from carrying a heavy backpack 1 can be relieved to some extended.

As shown, the massage unit 3 of the present invention is basically formed as a pad structure adapted to be mounted onto the back portion 10 of the backpack 1. In the first embodiment of the present invention, the massage unit 3 is formed as a structure having two parallel pads lining vertically on the back portion 10 of the backpack 1.

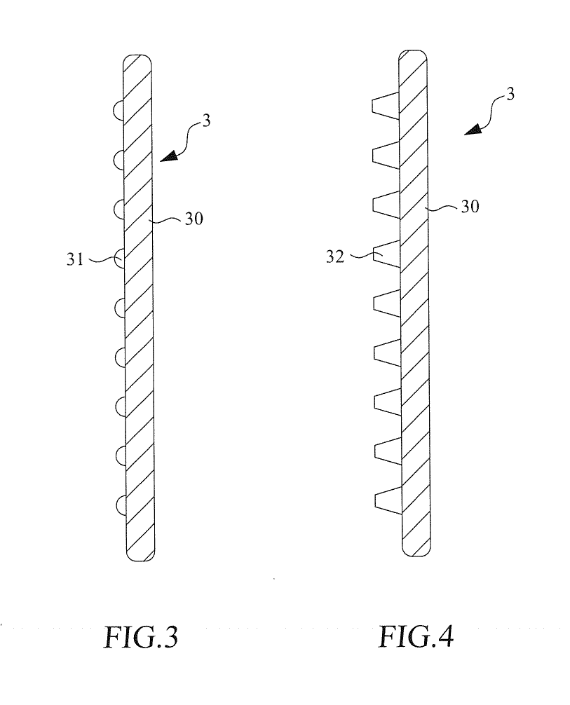

Referring to FIG. 3, it is a cross-sectional view taken along line 3-3 of FIG. 1. The massage unit 3 includes a base 30 and a plurality of protrusions 31 formed on the base 30. The base 30 is preferably made of flexible material. The protrusions 31 are protruded outward away from the base 30 with a predetermined height. The plurality of protrusions 31 are distributed in a predetermined discrete manner over the base 30.

In addition, since the protrusions 31 of the massage unit 3 have heights to space the back portion 10 of the backpack 1 and the back 41 of the user 4, so that a ventilation space W between the back portion 10 of the backpack 1 and the back 41 of the user 4 can be generated, as shown in FIG. 2, for improving the ventilation between the back portion 10 of the backpack 1 and the back 41 of the user 4. Thus, the possible localized temperature raised on the back 41 of the user 4 can be improved.

The protrusions 31 can be a round tip (as shown in FIG. 3). Optionally, he protrusions 31 can be a small flat tip 32 (as shown in FIG. 4) and any the like.

By providing the massage units 3 of the present invention, while the user 4 carries the backpack 1 on his/her back 41, the weight of the backpack 1 will induce a force to exert on the massage unit 3 and further be applied to the back 41 of the user 4 through the protrusions 31. With the help of the protrusions 31, a massage can be performed at the back 41 of the user 4. Definitely, as the weight of the backpack 1 increases, the magnitude of the force for performing the quasi massage would be respectively increased as well.

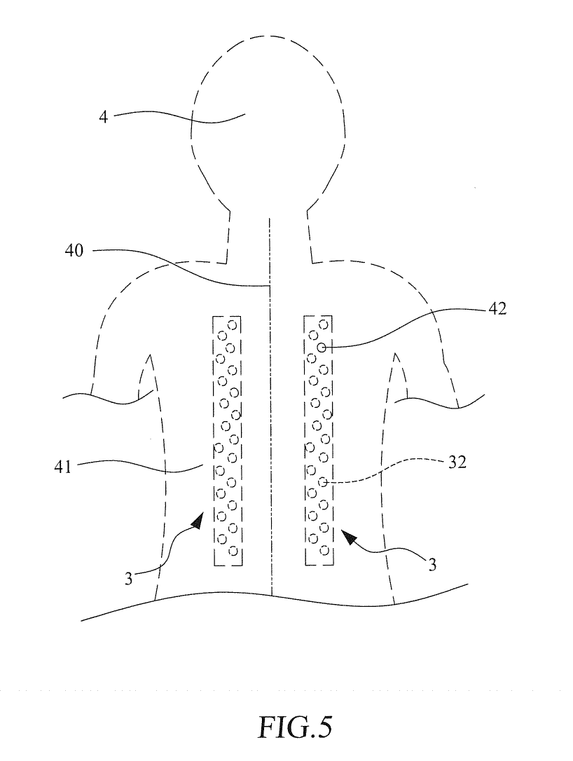

As shown in FIG. 5, by having the massage unit 3 to be arranged on the back portion 10 of the backpack 1 at positions corresponding to the erector inaemuscles at both sides of the spinal column 40 of the user 4, a better massage is applied onto the back 41 of the user 4 or a stimulation is applied right at an acupoint 42 of the back 41 of the user 4 carrying the backpack 1.

Since plenty of acupoints are distributed on the back 41 of the user 4, the protrusions 31 are preferably arranged to align with at least one specific acupoint 42 on the back 41 of the user 4. Namely, with appropriated stimulation on the back 41 of the user 4 by the protrusions 31 of the massage unit 3, the possible back pain can be substantially lessened.

As stated above, the depressing approximately on the massage points by the protrusions 31 of the massage unit 3 may thus improve local blood circulations around these certain locations on the back, and therefore can bring pain relief therearound.

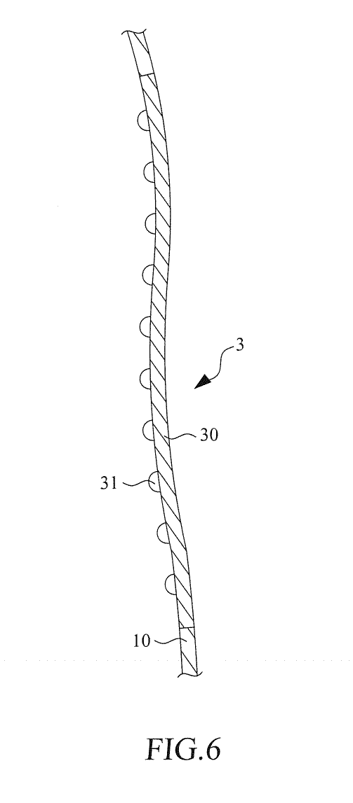

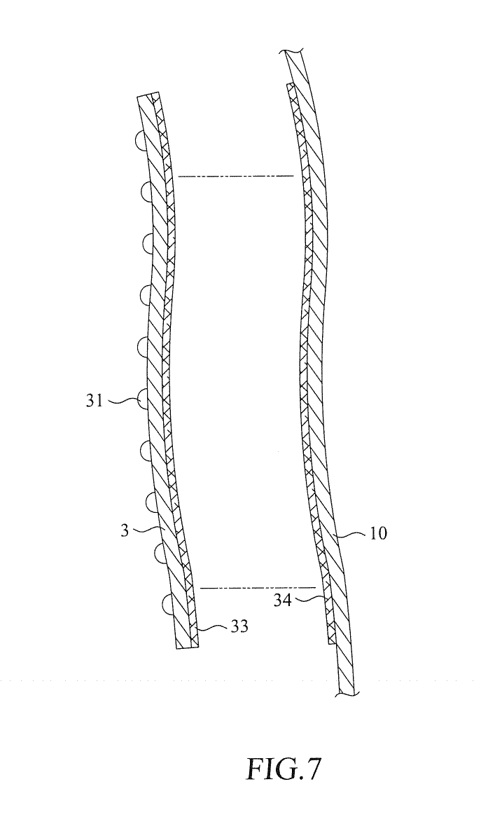

As shown in FIG. 6, the base 30 of the massage unit 3 can be integrated with the back portion 10 of the backpack 1. Alternatively, the base 30 of the massage unit 3 can be attached onto the back portion 10 of the backpack 1 by appropriate binding material. As shown in FIG. 7, the binding material may include a Velcro strip 33 cooperated with the base 30 of the massage unit 3 and a corresponding Velcro strip 34 cooperated with the back portion 10 of the backpack 1. The Velcro strip 33 and the corresponding Velcro strip 34 are known commonly under the trademark Velcro.

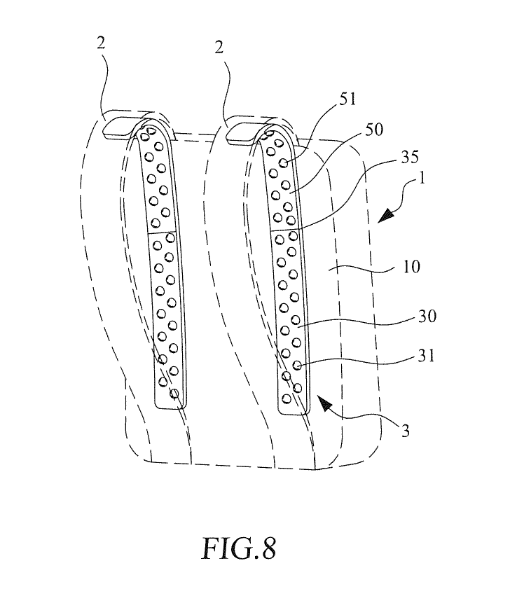

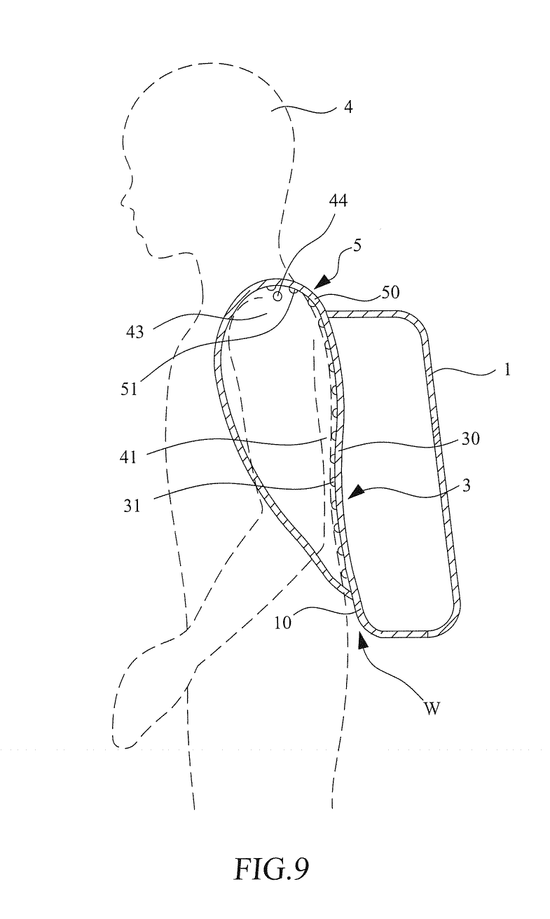

Referring now to FIG. 8, a schematic view of a second embodiment of the massage structure for a backpack in accordance with the present invention is shown. FIG. 9 is a schematic side view showing the backpack of FIG. 8 is carried by a user.

The instant embodiment comprises constituent components/parts that are similar to those of the first embodiment and similar components/parts are designated with the same reference numerals for consistency. In the instant embodiment, a difference from the first embodiment is that the massage unit 3 further comprises an extended base 50 upward extended from a top end 35 of the base 30 to the strap 2 of the backpack 1. The extended base 50 is also provided with a plurality of extended protrusions 51 thereon.

The extended protrusions 51 are protruded outward away from the extended base 50 with a predetermined height for applying a massage onto a shoulder 43 of the user 4 or applying a stimulation right at a shoulder acupoint 44 of the shoulder 43 of the user 4 carrying the backpack 1.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A massage structure for a backpack having a pair of straps connected with a back portion of the backpack, comprising a pair of spaced massage units mounted on the back portion of the backpack, each of the massage units comprising:
a base in a pad form; and
a plurality of protrusions formed on the base and arranged to align with at least one specific acupoint on a back of a user, each of the protrusions being protruded outward away from the base for applying a massage onto the at least one specific acupoint on the back of the user carrying the backpack.

2. The massage structure of claim 1, further comprising:
a pair of extended bases upward extended from a top end of each base to the straps of the backpack respectively; and
a plurality of extended protrusions formed on the extended bases and arranged to align with at least one specific shoulder acupoint on a shoulder of the user.

3. The massage structure of claim 1, wherein each of the protrusions comprises a round tip.

4. The massage structure of claim 1, wherein each of the protrusions comprises a small flat tip.

5. The massage structure of claim 1, wherein the base of the massage unit is integrated with the back portion of the backpack.

6. The massage structure of claim 1, wherein the pair of massage units are mounted on the back portion of the backpack with respect to a spinal column of the user and at positions corresponding to at least one erector inaemuscle of the user.

7. The massage structure of claim 1, wherein the base of the massage unit is attached onto the back portion of the backpack by binding material.

8. The massage structure of claim 7, wherein the binding material comprises a Velcro strip cooperated with the base of the massage unit and a corresponding Velcro strip cooperated with the back portion of the backpack.
